(19) United States
(12) Patent Application Publication
(10) Pub. No.: US 2013/0061328 A1
(43) Pub. Date: Mar. 7, 2013

(54) INTEGRITY CHECKING SYSTEM

(71) Applicants: Jacob Mendel, Kibbutz Givat Brenner (IL); Alexander Potievsky, Kfar Saba (IL); Eyal Webber-Zvik, Kfar Yona (IL)

(72) Inventors: Jacob Mendel, Kibbutz Givat Brenner (IL); Alexander Potievsky, Kfar Saba (IL); Eyal Webber-Zvik, Kfar Yona (IL)

(73) Assignee: Broadcom Corporation, Irvine, CA (US)

(21) Appl. No.: 13/480,308

(22) Filed: May 24, 2012

Related U.S. Application Data
(60) Provisional application No. 61/531,513, filed on Sep. 6, 2011.

(51) Int. Cl. G06F 21/00

(52) U.S. Cl. 726/25

(57) ABSTRACT

An integrity checking system provides improved monitoring of an electronic device for unauthorized access and modification. The integrity checking system includes a controller with a secure memory. The secure memory stores test profile information, such as test type, test subject, test action, expected test response, test frequency, and result action. The controller reads the test profile information and executes the defined tests to monitor the integrity of the device, and either permit normal operation, or execute the result action (e.g., terminate program execution) depending on the test results.

### CROSS REFERENCE TO RELATED APPLICATIONS

This application is related to and claims priority from U.S. Provisional Application Ser. No. 61/531,513, entitled “Integrity Checking System” and filed on Sep. 6, 2011, the contents of which are hereby incorporated by reference in their entirety.

### BACKGROUND

1. Technical Field

This disclosure relates to security checks in electronic devices. More specifically, this disclosure relates to integrity checking of a device to facilitate determining, for example, when unauthorized changes have been made to the device.

2. Related Art

For many years, significant advances in technology have driven strong growth in the availability and capability of electronic devices. As just a few examples, it is not unusual for a consumer to own one or more cell phones, laptops, tablet computers, Global Positioning System (GPS) devices, gaming systems, and televisions. Consumer electronics are only one segment of the total market for electronic devices, and today electronic devices are found virtually everywhere in society. Improvements in security measures for such devices will help continue to drive the widespread adoption and demand for such devices.

### BRIEF DESCRIPTION OF THE DRAWINGS

The system may be better understood with reference to the following drawings and description. In the figures, like reference numerals designate corresponding parts throughout the different views.

FIG. 1 shows an exemplary device in which integrity checks are performed.

FIG. 2 shows an example of a test profile for integrity checking a device.

FIG. 3 shows an example of logic that the device may execute to perform integrity checking.

FIG. 4 shows an example of a system executing a test result action.

FIG. 5 shows an example of logic that the device may execute to perform integrity checking.

### DETAILED DESCRIPTION

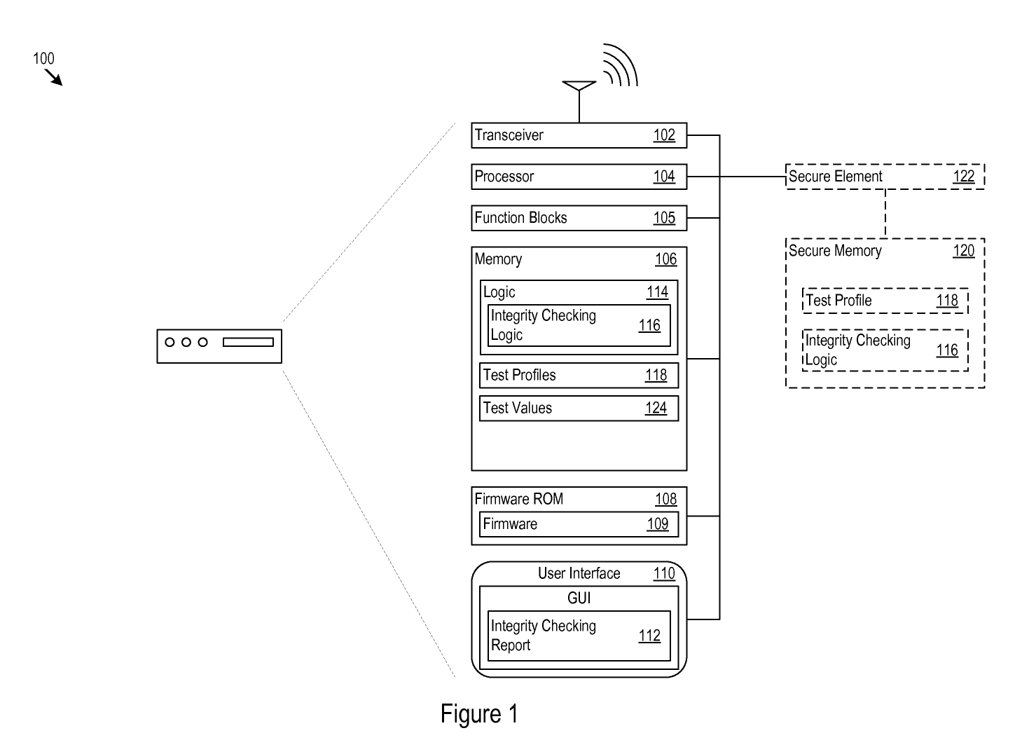

FIG. 1 shows an exemplary device 100 in which integrity checking is performed. The device 100 is a gaming system, in this example, but the device 100 may take any form. As examples, the device 100 may instead be a laptop, desktop, or other type of computer, a personal data assistant, or a portable email device. Additional examples of devices 100 include televisions, stereo equipment such as amplifiers, pre-amplifiers, and tuners, home media devices such as compact disc (CD)/digital versatile disc (DVD) players, portable MP3 players, high definition (e.g., Blu-Ray™ or DVD audio) media players, or home media servers. Other examples of devices 100 include vehicles such as cars and planes, societal infrastructure such as power plants, traffic monitoring and control systems, or radio and television broadcasting systems. Further examples include home climate control systems, washing machines, refrigerators and freezers, dishwashers, intrusion alarms, audio/video surveillance or security equipment, network attached storage, and network routers and gateways. The devices may be found in virtually any context, including the home, business, public spaces, or automobile. Thus, as additional examples, the devices may further include automobile engine controllers, audio head ends or DVD players, satellite music transceivers, noise cancellation systems, voice recognition systems, climate control systems, navigation systems, alarm systems, or other devices.

The device 100 includes a transceiver 102, one or more processors 104, and memories, such as the random access memory (RAM) 106, and a firmware read only memory (ROM) 108 that stores operational firmware 109. The device 100 includes other function blocks 105 as well. The device 100 also includes and a user interface 110 (displaying, for example, an integrity checking report 112). The transceiver 102 may be wireless transceiver, and the transmitted and received signals may adhere to any of a diverse array of formats, protocols, modulations, frequency channels, bit rates, and encodings that presently or in the future may support reverse direction protocols. Thus, the transceiver 102 may support the 802.11a/b/g/n/ac standards, the 60 GHz WiGig/802.11TGad specification, Bluetooth, Global System for Mobile communications (GSM), Time Division Multiple Access (TDMA), Frequency Division Multiple Access (FDMA), Code Division Multiple Access (CDMA), or other wireless access techniques or protocols.

The processor 104 executes the logic 114. The logic 114 may include an operating system, application program, firmware, or other logic. The logic 114 includes integrity checking logic 116 that helps monitor for, detect, respond to, and report anomalous changes to the device 100, such as those caused by unauthorized access and modification of the device 100.

The memory 106 may store testing profiles 118. In some implementations, the device 100 may alternatively or additionally include a separate secure memory 120 (described in more detail below) that stores the testing profiles 118 and/or the integrity checking logic 116, and a secure element 122 (e.g., a secure processor) that executes the integrity checking logic 116. The integrity checking logic 116 may switch testing profiles as desired or directed, e.g., by time, date, user input, or external command to switch to a different testing profile. The device 100 (e.g., via the processor 104 or secure element 122) performs integrity checks of the device 100 on a scheduled basis, periodic basis, continuous basis, or other basis. The information defining the integrity checking timing may be stored in the test profile 118 or may be part of the integrity checking logic 116, as examples. For example, for integrity checking on a continuous basis, the integrity checking logic 116 may execute integrity checks whenever the processor 104 or secure element 122 would otherwise be idle, at a predetermined frequency (e.g., 1 check each microsecond), or frequently enough to keep the processor 104 at at least a predetermined utilization percentage. Running integrity checks on a continuous basis may also include interleaving or time division multiplexing the execution of other programs running in the system 100 with the integrity checking logic 116 itself.

According to the test profile 118, the device 100 may perform integrity checks of any part or parts of the device. For example, the secure element 122 may query (e.g., by reading) the memory 106 or ROM 108 and obtain a response (e.g., by receiving a value). Queries may also be sent by issuing commands to circuitry or taking other actions that provoke a response from circuitry in the device 100. Other examples of integrity checks include cyclic redundancy checks (CRC) and hash value checks. The secure element 122 may perform an integrity check on any of the function blocks 105 in the device 100 that support a query/response paradigm. Some examples of the function blocks 105 include communication ports (e.g., universal serial bus (USB) ports), graphics processing units (CPUs), memory systems, one or more processor cores, disc drives, input/output controllers, basic input/output system (BIOS) ROMs, or audio processing logic.

The test profile 118 may define integrity checks against the circuitry in the device 100. The integrity checks may be expressed as a test type, test action, and expected test response. For example, the test type may be ‘authentic’ for a check for which the response is actually analyzed and considered, or may be ‘obfuscate’ for a check for which the response is not analyzed nor considered (e.g., a dummy check). The obfuscatory checks may be, in one implementation, between 5% and 30% of the integrity checks executed in the system, though other percentages may also be implemented. In other words, the integrity checking logic 116 may mix its real queries with illusory queries to create an additional level of security against unauthorized access and modification of the device 100. The test action may identify the action that the integrity checking logic 116 will take, such as reading a value (data or code) from a memory location, writing a value (data or code) to a memory location, performing an input/output operation, reading a timer, or other action. The expected test response may identify the correct value (or range of values) expected in response to the test action. For example, for the test action: read a 4 byte value starting at memory location 0x003034FFAC, the test response may be: AF 55 03 CC. In some implementations, the memories may be preconfigured with predefined expected test values 124 for the integrity checking logic to read and test.

The test profile 118 may also define result actions. The result actions identify what steps to take when an integrity check fails. For example, if the integrity check on the memory 106 fails, then the result action may be to display an integrity check failure in the integrity checking report 112, and halt all program execution. As another example, the result action may be to lock the device to prevent input, output, processing functions, or any combination thereof, communicate an integrity check failure message through the transceiver 102 to a remote monitoring system or device, or take some other responsive action.

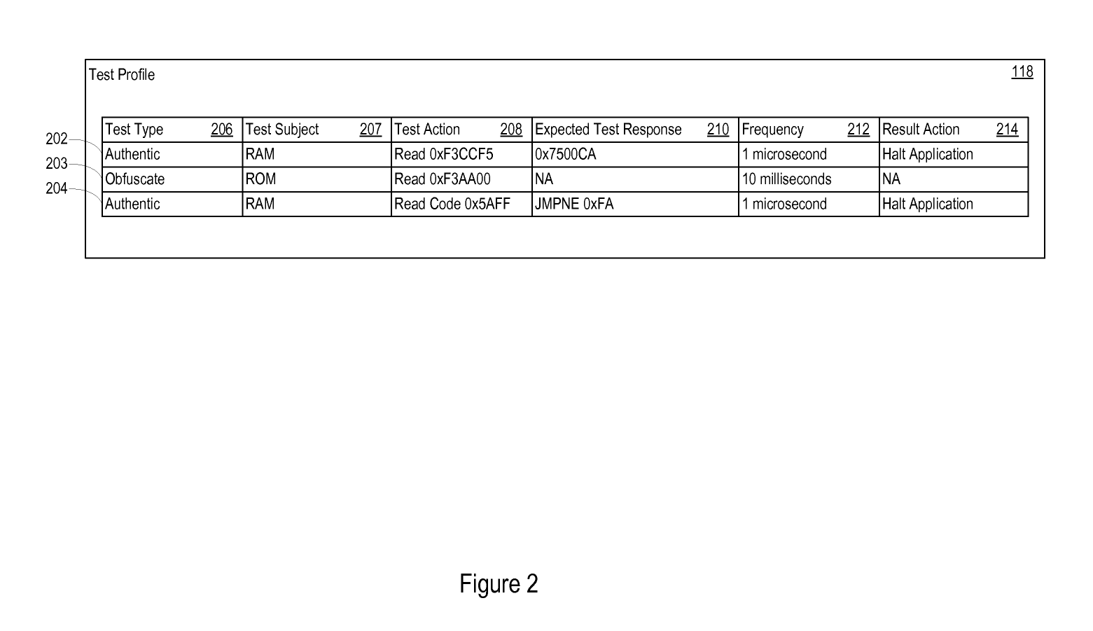

FIG. 2 shows an example of a test profile 118 for integrity checking a device. The test profile 118 may take many different forms, however. In the example shown, the test profile 118 includes three integrity tests 202, 203, and 204, though there may be any number of such integrity tests defined in the test profile 118. The integrity tests may be predefined in the system based on the system components and applications present in the system. In addition, external providers of integrity checks may communicate additional integrity checks or integrity checking logic 116 to the system 100 (e.g., via the transceiver 102), optionally encrypted for decryption and verification in the device 100 prior to installation. This may occur when, for example, additional application software is installed on the device 100 and contacts the external provider as part of a configuration step, or at other times when additional or different device configurations warrant additional, fewer, or different integrity checks.

Each integrity test 202, 203, and 204 includes the following fields: a test type 206, a test subject 207, a test action 208, an expected test response 210, a test frequency 212, and a result action 214. The integrity test 202 specifies an ‘authentic’test, e.g., one for which the integrity checking logic 116 determines whether the received test response matches the expected test response 210. If the received test response does match, then the integrity checking logic 116 allows device operation to continue normally. However, if there is not a match, then the integrity checking logic 116 executes the result action ‘Halt Application’. Such an action may suspend or terminate execution of any particular application identified by the result action that may be compromised by the failure of the test, such as a banking application, word processor, encryption application, or any other application. The integrity test 202 is executed every microsecond.

The integrity test 203 specifies an ‘obfuscate’ test, e.g., one for which the integrity checking logic 116 executes the test, but ignores any results. Accordingly, the expected test result and result action are Not Applicable (NA). The integrity test 203 is executed every 10 milliseconds. The integrity test 204 specifies an ‘authentic’ test of code executing in RAM at address 0x5AFF, which is read and compared to the expected code instruction JMPNE 0xFA every microsecond. If the expected code is not present, the integrity checking logic 116 halts the application.

There may be any number of additional or different testing parameters for any integrity test. There may be any number of test actions 208 or expected test results 210 defined for any integrity test. The test profile 118 may be set by the device user, may be set by a company that supplies system software or firmware for the device, or may be set by another entity.

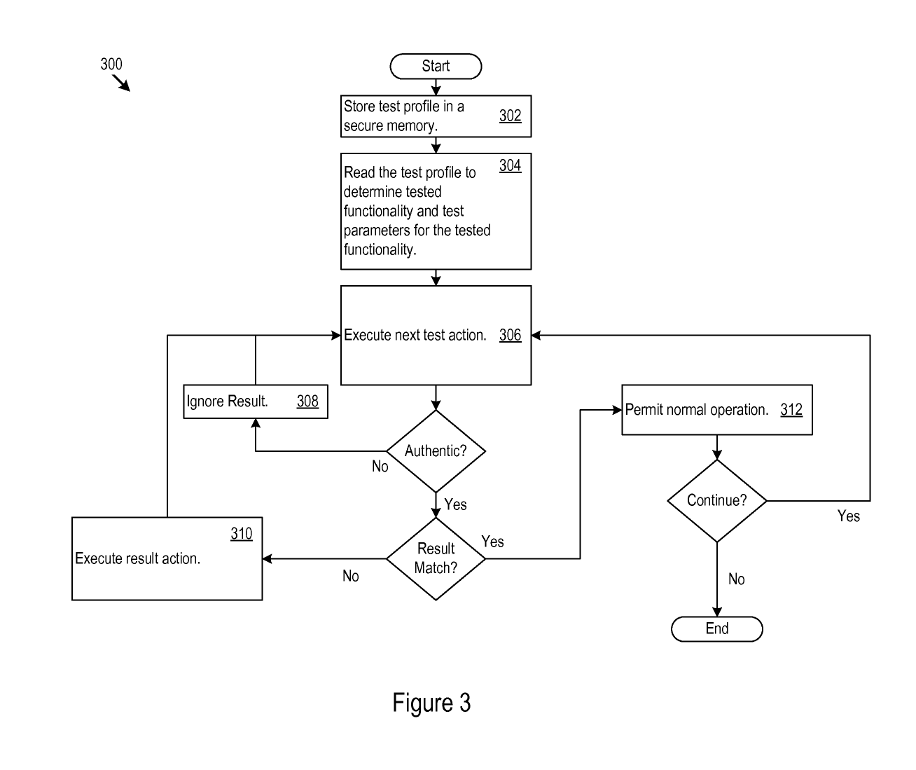

FIG. 3 shows an example of logic 300 that the device 100 may execute to perform integrity checking. The logic 300 may implement the integrity checking logic 116. The logic 300 may store a test profile 118 in a memory, such as in the secure memory 120 (302). Each test profile may apply to one or more devices, parts of a device, functionality within the device, or other testable aspect of the device. The integrity checking logic 116 reads the test profile 118 to determine tested functionality (e.g., the test subject) and test parameters (e.g., the test type, the test action, the expected test response, frequency, and result action) for the tested functionality (304). The integrity checking logic 116 executes the test action (306). If the test type is not ‘Authentic’ (e.g., the test type is ‘Obfuscate’), then the integrity checking logic 116 may ignore any result of the test action (308) and continue to execute integrity tests that are specified in the test profile.

However, when the test action is an authentic test action, then the integrity checking logic 116 may determine whether the test result matches the expected test result. If there is no match, the integrity checking logic 116 executes the test result action (310). Examples of test result actions include halting execution of one or more (or all) programs, displaying a warning or error message, and communicating an alarm to an external monitoring system. On the other hand, if the test result matches, then the integrity checking logic 116 may permit normal operation of the device 100 (311).

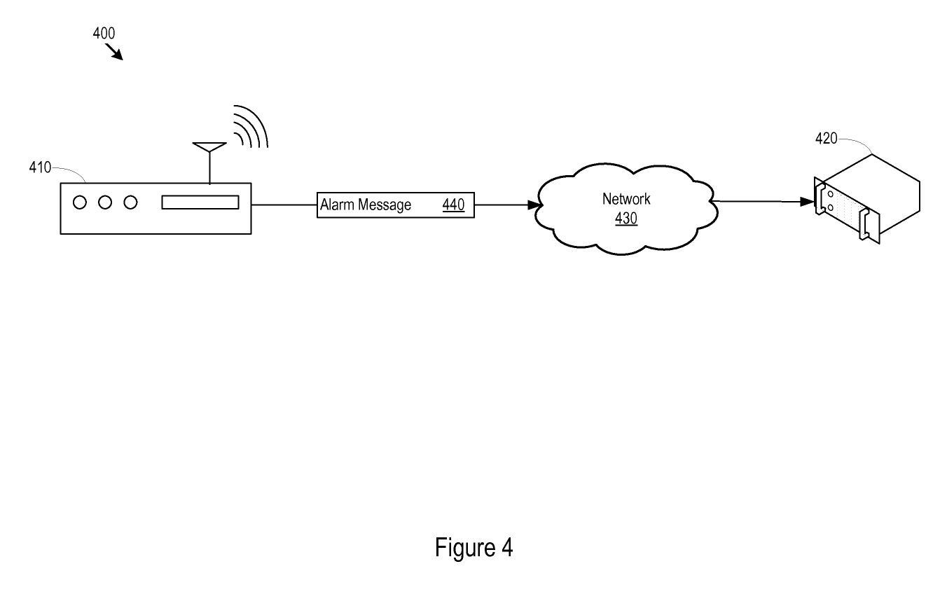

FIG. 4 shows an example of a system 400 executing a test result action. The exemplary system 400 includes a device 410 that is communicatively coupled to a remote monitoring system 420 through a network 430. The device 410 may be similar to the device 100, and may include integrity checking logic 116 to perform integrity checking, as described above. The integrity checking logic 116 of the device 410 may execute an authentic test action. As shown in FIG. 4, when the test results do not match the expected test results, the integrity checking logic 116 may execute a test result action by sending a reporting message to the remote monitoring system 420. For example, in FIG. 4, the device 410 sends an alarm message 440 to the remote monitoring system 420 that may indicate that tested functionality on the device 410 has failed an integrity check.

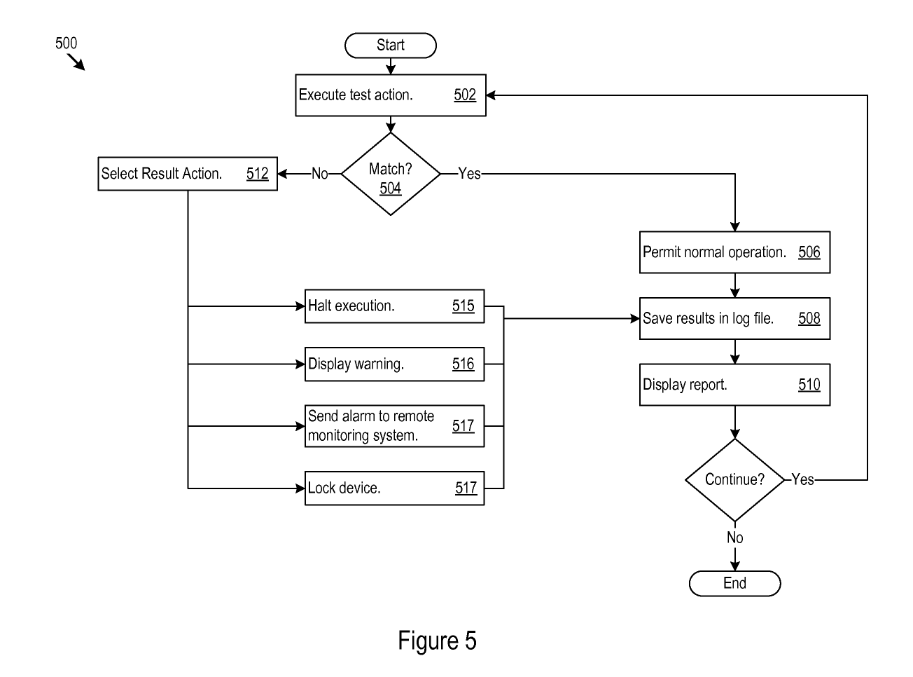

FIG. 5 shows an example of logic 500 that the device 100 may execute to perform integrity checking. The logic 500 may implement the integrity checking logic 116. The integrity checking logic 116 may perform an integrity check by executing a test action (502). The integrity logic 116 may then determine whether the test result from the test action matches an expected test result (504). If the test result matches the expected test result, the integrity checking logic 116 may permit normal operation of the device 100 (506). The integrity checking logic 116 may save the results of the integrity check in a log file (508) and display the results of the integrity check to a user (510), for example by displaying an integrity checking report through a user interface of the device 100.

If the test result from the test action does not match an expected test result, the integrity checking logic 116 may select one or more result actions (512) to execute, for example, from test actions stored in a test profile 118. As seen in the exemplary logic 500 shown in FIG. 5, the integrity checking logic 116 may execute a result action that halts execution of a program executing on the device 100 (515), displays a warning to a user (516), sends an alarm, e.g., the alarm message 440, to a remote monitoring system (517), or locks the device 100 (518). After executing the result action(s), the integrity checking logic 116 may save the results of the integrity check in a log file (508), which may include saving the executed result action(s). The integrity checking logic 116 may then display the results of the integrity check to a user (510).

Thus, the device 100 implements a hardware and software integrity check, which the device 100 may continuously execute, or execute on any other schedule. Aspects of a device that are tested may include ROM code, RAM data application code and data, and other aspects. The results of each integrity check may be stored in a log file in the memory in the device for later analysis, or may be displayed or communicated to other entities as the integrity checks happen. The integrity checks may be authentic or obfuscatory checks, and the interleaving of these checks may appear as a form of white noise in the system. In other words, the system may act as a white noise generator. To a potential attacker of the device, the integrity checks may appear as continuous activity (e.g., monitoring) in the device, continuously monitoring the device, even though some of the integrity checks are dummy checks.

The secure element 122 and secure memory 120 may be secure in many different senses. As examples, the secure element 122 and secure memory 120 may be difficult to access physically or electrically. As examples, the secure element 122 and secure memory 120 may be located in a difficult to access part of the device, may be hidden or incorporated into other circuitry, including the processor 104, or may be covered in a protective coating (e.g., a sealing epoxy). As additional examples, the secure element 122 and secure memory 120 may be connected to the rest of the device via encrypted communication channels, may be monitored by tamper detecting sensors, including temperature, light, and access sensors in the device, or may be secured in other ways.

In one implementation, an electronic device may include a memory storing a first test profile, a second test profile, and integrity checking logic. The electronic device may also include an element (e.g., the secure element 122) that is operable executes the integrity checking logic and read the first test profile to determine a first tested functionality in the device and first test parameters for the first tested functionality. The element may also execute the integrity checking logic to perform an integrity check on the first tested functionality according to the first test parameters, and execute a result action when a received test response does not match an expected test response.

The element may be further operable to switch from the first test profile to the second test profile, which may include reading the second test profile to determine a second tested functionality in the device and second test parameters for the second tested functionality as well as performing the integrity check on the second tested functionality according to the second test parameters. As one example, the first tested functionality is the same as the second tested functionality. Or, the first tested functionality may be different, at least in part, from the second tested functionality. The element may switch to the second test profile based on a time, a date, user input, an external command, or any combination thereof.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method comprising:
in an electronic device:
storing a test profile in a secure memory;
reading the test profile with a secure element, thereby determining:
tested functionality in the electronic device; and
test parameters for the tested functionality;
determining when the tested functionality provides an expected test response according to the test parameters; and
executing a result action when the tested functionality does not provide the expected test response.

2. The method of claim 1, where executing comprises:
terminating execution of a program running in the electronic device.

3. The method of claim 1, where executing comprises:
communicating an integrity check failure message to a remote monitoring system.

4. The method of claim 1, where executing comprises:
preventing an input function, an output function, a processing function, or any combination thereof in the electronic device.

5. The method of claim 1, where executing comprises:
displaying an integrity check failure message on a user interface of the electronic device.

6. The method of claim 1, further comprising:
receiving the test profile from an external provider.

7. The method of claim 6, where receiving comprises:
decrypting the test profile received from the external provider; and
verifying the test profile prior to storing the test profile in the secure memory.

8. A device comprising:
a memory comprising:
a test profile; and
integrity checking instructions; and
logic operable to, when it executes the integrity checking instructions:
read the test profile to determine:
tested functionality in the device; and
test parameters for the tested functionality;
perform an integrity check on the tested functionality according to the test parameters;
obtain a received test response from the tested functionality; and
execute a result action when the received test response does not match an expected test response.

9. The device of claim 8, where the test parameters comprise:
a test type parameter specifying a test type of the integrity check.

10. The device of claim 9, where the logic is operable to implement the test type by ignoring the received test response.

11. The device of claim 9, where the logic is operable to implement the test type by determining whether the received test response matches the expected test response.

12. The device of claim 8, where the test parameters comprise an integrity checking timing parameter, where the integrity checking timing parameter specifies when the logic performs the integrity check on the tested functionality.

13. The device of claim 12, where the integrity checking timing parameter specifies that the logic perform the integrity check when the logic would otherwise be idle, at a predetermined frequency, at a rate to keep the logic above a predetermined utilization percentage, or any combination thereof.

14. The device of claim 8, where the test parameters comprise a test action parameter that specifies an action for the logic to take to perform the integrity check.

15. A device comprising:
a memory comprising:
a first test profile;
integrity checking instructions; and
a processor operable to, when it executes the integrity checking instructions:
read the first test profile to determine:
first tested functionality in the device; and
first test parameters for the first tested functionality;
perform an integrity check on the first tested functionality according to the first test parameters;
obtain a test response to the integrity check;
select between ignoring the test response and executing a result action when the received test response does not match an expected test response.

16. The device of claim 15, where:
the memory further comprises a second test profile; and
the processor is further operable to, when it executes the integrity checking logic:
switch from the first test profile to the second test profile by:
reading the second test profile to determine:
second tested functionality in the device; and
second test parameters for the second tested functionality; and
performing the integrity check on the second tested functionality according to the second test parameters.

17. The device of claim 15, where the integrity check comprises an obfuscating integrity check.

18. The device of claim 17, where the obfuscating integrity check causes the processor to ignore the test response.

19. The device of claim 16, where the logic is operable to switch to the second test profile based on a time, a date, user input, an external command, or any combination thereof.

20. The device of claim 15, where the result action comprises locking the device to prevent input, output, processing functions, or any combination thereof.
